(19) United States
(12) Patent Application Publication
(10) Pub. No.: US 2016/0320949 A1
(43) Pub. Date: Nov. 3, 2016

(54) METHOD AND APPARATUS FOR PRESENTING MEDIA SERVICE AND ASSET INFORMATION

(71) Applicant: TECHNICOLOR LICENSING, Issy les Moulineaux (FR)

(72) Inventors: Ronald C. DOLLETE, Los Angeles, CA (US); Norbert L. PIEGA, Chino Hills, CA (US); Kevin LUDWIG, Simi Valley, CA (US); Stelian MARKOV, La Crescenta, CA (US); Shea RYAN, Culver City, CA (US)

(21) Appl. No.: 15/108,304

(22) PCT Filed: Dec. 27, 2013
(86) PCT No.: PCT/US2013/078035

§ 371 Date: Jun. 26, 2016

(51) Int. Cl. G06F 3/0484; G06F 17/30

(52) U.S. Cl. CPC G06F 3/04842; G06F 17/30058; G06F 17/30023

(57) ABSTRACT

A procedure (400) is disclosed for rendering information comporting to a media asset or service. A determination is made as to whether or not a party that requests such information is registered with a media service (402). An additional determination is made as to whether a device at the destination address that will receive such information is registered with a media service (404). Proprietary elements will be transmitted to the destination address if the requesting party and the receiving device are registered with a media service, while public elements will be transmitted to the destination address if either the requesting party or the receiving device at the destination is not registered with the media service (406).

### TECHNICAL FIELD

The disclosure is directed towards a method and apparatus for providing information about media assets and media services, and more particularly to a method and apparatus for providing different types of information about media assets and media services depending on the parties requesting and receiving such information.

### BACKGROUND

When a user accesses a media service such as AMAZON, ITUNES, M-GO, VUDU, and the like, the user can search for different media assets which can either be rented or purchased for a media device. Part of the searching process has the user referencing various information comporting to such media assets such as a synopsis of a media asset, who starred or directed a media asset, what were the reviews of a media asset, and the like. From such information, the user selects the appropriate media asset according to the preferences of the user.

Sometimes, there will be special information that is associated with a media service or media asset such as trailers, actor or director commentary, poster art, videos, audio, and the like. Such special information is made for limited release to a select group of users for promotional purposes where a content creator such as a movie studio or record company does not want such special information available to a wide audience. Moreover, such special information can be used by a media service in an attempt to encourage people to join the media service and to purchase or rent a media service from the media service without having the people go to a competitor of the media service.

Thus, a method and apparatus are needed to preserve the interests of the content creators from having special information be widely disseminated while allowing for a media service to encourage users to join and purchase or rent media assets from the media service.

### BRIEF SUMMARY

One embodiment of the disclosure describes a method and apparatus for rendering information comporting to a media asset or service. A determination is made as to whether or not a party that requests such information is registered with a media service. An additional determination is made as to whether a device at the destination address that will receive such information is registered with a media service. Proprietary elements will be transmitted to the destination address if the requesting party and the receiving device are registered with a media service, while public elements will be transmitted to the destination address if either the requesting party or the receiving device at the destination is not registered with the media service.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering content to a user in accordance with the principles of the present disclosure;

FIG. 2 shows a block diagram of an embodiment of a server in accordance with the principles of the present disclosure;

FIG. 3 shows a block diagram of an embodiment of a playback device in accordance with the principles of the present disclosure;

FIG. 4 presents a flow chart of an embodiment that determines whether to transmit proprietary or public elements to a destination device in accordance with the principles of the present disclosure;

FIG. 5 presents a user interface displaying an a user created media asset list accordance with the exemplary principles of the present disclosure;

FIG. 6 presents a user interface displaying video trailers of media assets accordance with the exemplary principles of the present disclosure;

FIG. 7 presents a user interface displaying pictures of media assets in accordance with the exemplary principles of the present disclosure; and

FIG. 8 presents a user interface displaying an option join a media service in accordance with the exemplary principles of the present disclosure.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the Figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate instructions. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Using the disclosed inventive concepts, the principles discussed below present a scenario where media assets can be purchased and rented from a media asset service such as M-GO, NETFLIX, AMAZON, VUDU, and the like. Media assets can be in the form of a movie, television show, video, audio program, music, podcast, video game, and the like.

A content creator is a movie studio, television studio, video creator, record company, video game company, broadcast network, and the like that create media assets. For example, Walt Disney Studios is a content creator that creates movies, television shows, video games, music, and the like. Time Warner is another example of a content creator that creates media assets as well through various divisions such as Time Warner Music, Warner Brothers Studios, and Warner Brothers Game Studios. Other examples of content creators are to be considered in accordance with these principles. The term content creator and content provider are used interchangeably within the specification.

An exemplary representation of a media service can be any format or information that is used by such a media service to describe a media asset available from the media service. Such a description can be in the form of text, video, audio, picture, web page, trailers, actor or director commentary media detail information corresponding to a media service or asset, poster art corresponding to a media service or media asset, list of media assets, information screen and the like. Additional exemplary representation of a media service can also be a description of the media service itself.

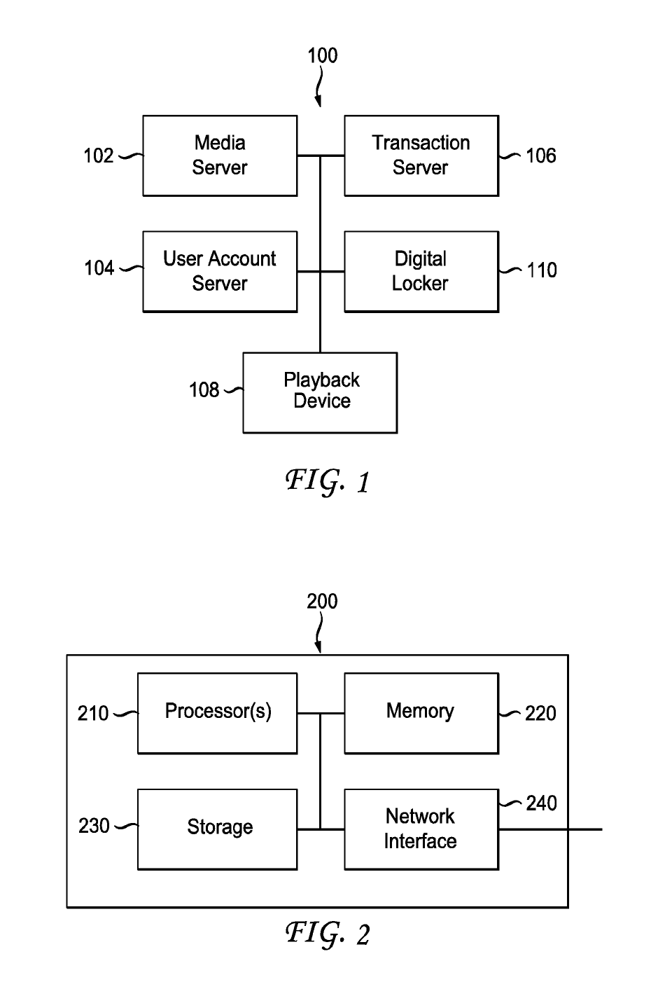

FIG. 1 shows a block diagram of an embodiment of a system 100 for delivering content to a user in accordance with the principles of the present disclosure where each of the display components are coupled to each other using a network connection, wired connection, wireless connection, and the like. Media server 102 is configured to supply media assets, representations of media services and media assets, and information about media services and media assets, to playback device 108 in response to the following actions including when a user requests information about a media service, when a user requests information about a media asset, when a user purchases a media asset or when a user rents a media asset. The transactional data corresponding to when a user purchases or rents a media asset can come from transaction server 106 that provides a user with the ability to purchase/rent a media asset using payment information, Quick Response (QR) code, alphanumeric code, code from a gift card, and the like. Ideally, transaction server 106 will authorize the transmission of a media asset from media server 102 when the transaction for the media asset is accepted by transaction server 106.

Transactional data about a rental or purchase of a media asset can also be stored in user account server 104 that stores various user information about what media assets a user has rented and/or purchased in the past. Such transactional data can be provided by transaction server 106. User account server 104 can also be configured to store data about what media assets a user has stored in digital locker 110 as a result of a purchase. Digital locker 110 can be a server such as AMAZON CLOUD, GOOGLE PLAY, M-GO STORAGE LOCKER, DROPBOX, and the like where a user can have different media assets stored within the server or plurality of servers comprising digital locker 110. Optionally, a user can also store media assets that are ripped from various physical media such as a compact disc, DVD, Blu-Ray, and the like where the user obtains a digital version of the media asset from such a ripping operation.

User account server 104 also stores information about what users and devices that are registered with a media service. User account server 104 can determine when a request is made for a representation of a media service or asset and who requested such information. The requestor can be identified, for example, by referencing the internet protocol address that can be part of such a request. User account server 104 can also determine whether or not a destination address and a device at such a destination address are registered with a media service. This determination can be made by referencing the internet protocol address that is part of the destination request. Other examples of such requests are possible in accordance with the disclosed principles.

Referring back to media server 102, a database can be implemented in the memory 220 or storage 230 (shown in FIG. 2) of server 102 that stores different class information about different media assets. For example, the database can store information that indicates which media assets are sequels of each other, remakes of each other, from the same television series, from the same movie series, from the same content creator, from the same video game series, and the like. The database can also be configured to store information for a media asset about the different quality version of a media asset that are available which can be a standard definition version, a high definition version, a 4K version, an ultra-high definition version, and the like.

The database in media server 102 can also be configured to store information about media assets and media services that can be descriptions of media assets and media services, audio/videos comporting to different media assets, trailers, text, video, audio, picture, web page, trailers, actor or director commentary media detail information corresponding to a media service or asset, poster art corresponding to a media service or media asset, list of media assets, information used to render information screens, and the like.

Some of the information stored in the database of media server 102 is referred to as proprietary elements which are specific types of media and information that correspond to media services and media assets that are only made available to users who have registered with a media service. Typically, a content creator or media service wants to restrict proprietary elements to a limited number of users. For example, a director can release a commentary track that would be played back with a movie, or a special soundtrack is made available to users who purchase or rent a media asset. Other examples can be implemented in accordance with the exemplary principles.

Other information stored in the database comports to public elements which are elements that refer to media services and media assets that are made available to everyone regardless of whether or not a party is a registered user of a media service.

Media server 102 can also be configured to let a user create a listing of one or more media assets that are the favorite of the user. This can be done by done by adding media assets to a list using text entry, dragging and dropping a representation of the media service into a list, and the like. When such a list is formed, different representation of media assets are shown in such a list. In an exemplary embodiment of the disclosed principles, only proprietary elements will be shown in the list of media assets if a user who creates the list is registered with a media service. In another exemplary embodiment, only public elements will be shown in the list of media assets if a user is not registered with a media service. Such a determination of whether or not a user is registered with a media service can be made by using user account server 104.

The database of media server 102 can also be further configured to make media server 102 into a media asset provider. That is, media server 102 will manage the purchase and delivery of media assets over a network using information from user account server 104 and transaction server 106.

In an optional embodiment, media server 102, user account server 104, transaction server 106, and digital locker 110 are all integrated into the same server or a plurality of servers in accordance with the described principles.

Playback device 108 can be configured to provide a user with the ability to select a media asset, purchase a media asset, and playback a media asset purchased from media server 102 and transactional server 108. That is, playback device 108 can manage user account operations, purchase operations, and playback operations through the use of a media asset provider. Playback device 108 can be a computer, video game system, display device, tablet, phone, smart watch, set top box, electronic book reader, digital audio music player, and the like.

FIG. 2 depicts an exemplary server 200 that can be used for implementing any one of the media server 102, user account server 104, transaction server 106, digital locker 110, and the like. The server, includes one or more processors 210, memory 220, storage 230, and a network interface 240. Each of these elements will be discussed in more detail below.

The processor 210 controls the operation of the server 200. The processor 210 runs the software that operates the server as well as provides the functionality of the software required to operate any one of the servers (102, 104, 106, 110). The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media. Memory 220 can be configured to operate a database to support any one of the operations required for servers (102, 104, 106, 110) in accordance with the described principles under the direction of processor 210.

The storage 230 is where data is stored for the use of processor 210 in executing the described operations. Storage 230 can be magnetic media (hard drive), optical media (CD/DVD-Rom), or flash based storage. Storage 230 can be configured to operate a database to support any of the operations required for server (102, 104, 106, 110) in accordance with the described principles under the direction of processor 210. Storage 230 can also be configured to store information comporting to user account data, transaction data, information comporting to previous media asset transactions by a user, media assets, and the like.

Network interface 240 handles the communication of server 200 with other devices over a network. Examples of suitable networks include Ethernet networks, Wi-Fi enabled networks, cellular networks, and the like. Other types of suitable networks will be apparent to one skilled in the art given the benefit of this disclosure.

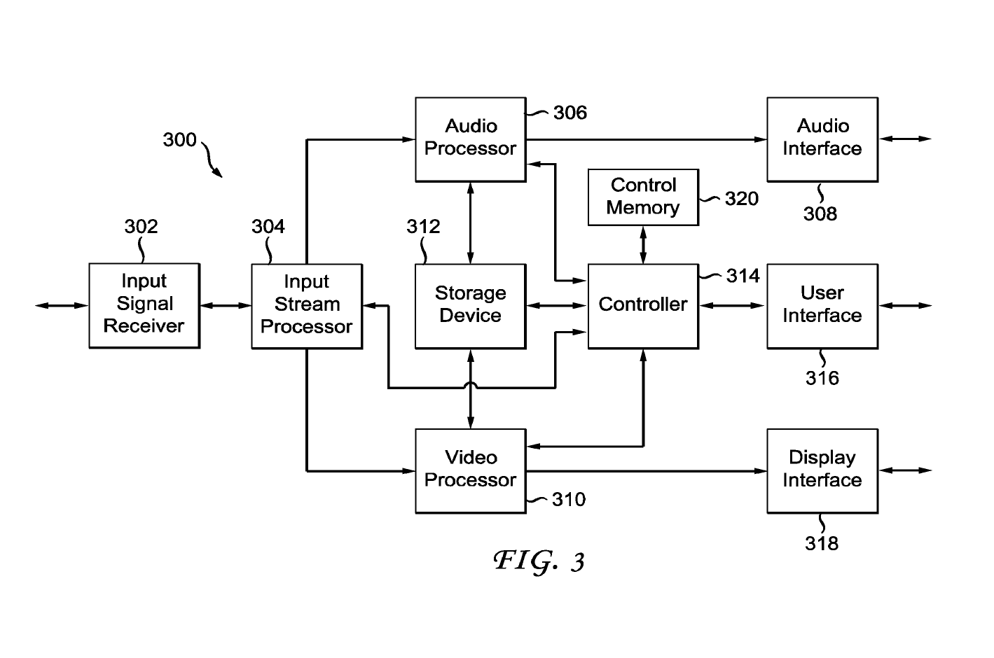

In the playback device 300 shown in FIG. 3, media assets are received in an input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

Storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI).

Controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 316 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

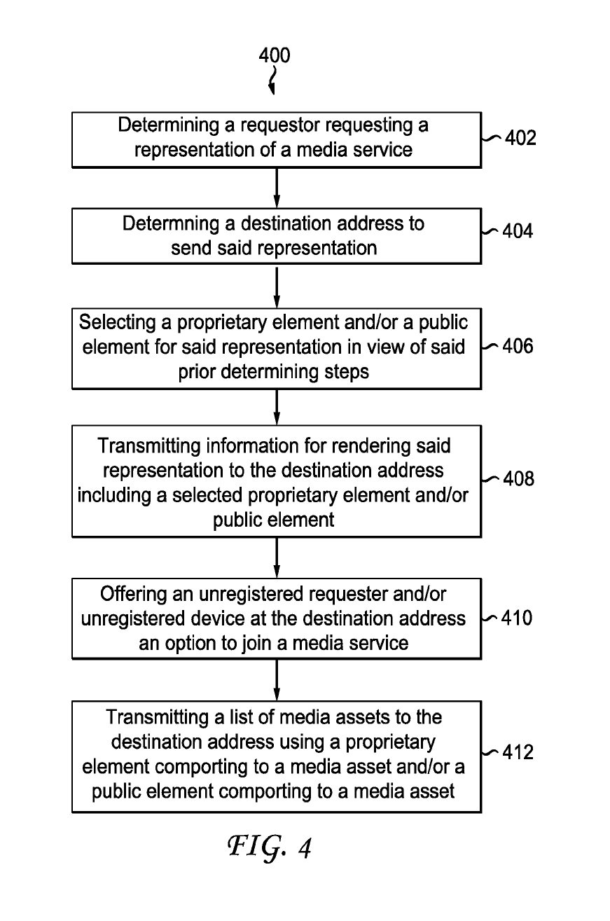

FIG. 4 presents a flow chart of 400 an exemplary method for determining what elements should be transmitting to a device at a destination address. Specifically, the method is used to provide a user with information about a media service and/or asset where the provided information is composed of proprietary and public elements. In step 402, a request is received by media server 102 by a requestor for a representation of a media service (media asset). In this step, a determination/identification is made about the party that is requesting the representation of the media service. In the present example, the representation of a media service can be a request for an information screen that contains poster art that corresponds to a specific media asset. The request for such a representation can be in the form of a four part command as shown in TABLE I, although other command representations and be used in accordance with the exemplary principles.

Requestor ID represents the internet protocol address of the party requesting a specific representation of a media service. The requestor can be a person who is registered with a media service, a person who is not registered with a media service, the media service itself, and the like. Media asset/service being requested is information about the media asset or service that is being requested by a requestor. In this exemplary embodiment, an ID is used to reference the specific media asset/service, although other information can be used.

The destination of the request represents where the representation of a media asset/service should be sent. In the present example, the destination represents an internet protocol address where a playback device 300 can reside. The destination address information can also be a web address, e-mail address, user account information, and the like.

Auxiliary information represents any additional information that can be part of the request for a media service/asset representation. In the present example, auxiliary information indicates whether or not a media asset/service representation can be copied or not.

TABLE I

| Command Format | Information in Command |
|---|---|
| Requestor ID | Internet Protocol Address of Requestor |
| Media Asset/Service | ID of Media Asset/Service being |
| Requested | requested |
| Destination Address | Internet Protocol Address of |
| for Request | Destination of where Information will be |
| | Transmitted |
| Auxiliary Information | Auxiliary Information about request |
| | including Digital Rights Management |
| | Information |

Referring back to step 402, the determination or identification is primarily made to verify whether or not the requestor is registered with a particular media service. By using the Requestor ID in such a request and by comparing such information to user account server 104, media server 102 can verify the status of the requestor. In an optional embodiment, if the media service itself is the requestor, step 402 will verify that the media service is a “registered” user.

In step 404, a determination is made whether the destination address for the representation corresponds to a registered user of a media service. This determination can be made by referencing the information in the destination address of the request and comparing such information to data that resides within the user account server 104, although alternative approaches can be implemented in accordance with the exemplary embodiments. Ideally, the determination of step 404 includes a check on whether or not a playback device 300 that resides at the destination address is registered with the media service. This can be performed by checking the media access control address of the device against information in user account server 104.

Step 406 is then performed where a selection is made as to what elements from media server 102 are to be used in the rendering of the representation of a media service. If it is determined that from step 402 that the requestor of the representation is a registered user of a media service and from step 404 that a device at a destination address is registered with a media service, proprietary elements will be selected for the representation of a media service. If step 406 determines that a requestor in 402 or device in step 404 is not registered with a media service, the representation will use public elements. That is, in an embodiment, both the requestor and the destination device need to be registered in order for proprietary elements to be transmitted. Hence, in the present example, the proprietary elements can be exclusive poster art that is used to render a representation of a media service, while the public elements can be mere text. Other examples, can be used in accordance with the disclosed principles.

In step 408, information is transmitted to the destination address which can be used to render the representation of the media service. Such a representation will include the proprietary and/or public elements that were selected in step 406. The information that is transmitted can be a combination of video, audio, text, and pictures in accordance with the exemplary embodiments.

In step 410, if it is determined previously that a requestor or a device at a destination address is not registered with a media service from steps 402 and 404, information can be sent to the non-registered user to register with the media service. For example, the non-registered requestor or owner of a non-registered playback device at the destination address can receive an e-mail invite to join the media service. Non-registered parties can also be sent special offers to join a media service and/or notifications that special content can be made available if the party joins the media service.

In step 412, a list of media assets are transmitted to the destination address. In this specific step, the list of media assets have been pre-selected by a user in the form of a playlist or other type of listing which can be grouped under a heading such as “scary movies”, “happy television shows”, and the like. Before information representing the list is transmitted to a destination device, a determination is made as to whether proprietary elements comporting to a media asset on such a list should be used to render such a list, or public elements comporting to a media asset on such a list should be used. Specifically, if it determined in step 412 that the list requestor and the destination device to receive the list are registered with a media service, then the proprietary elements will be sent to the destination address. If it is determined that either the list requestor or the destination device are not registered with the media service, then public elements will be used to generate the list sent to the destination address.

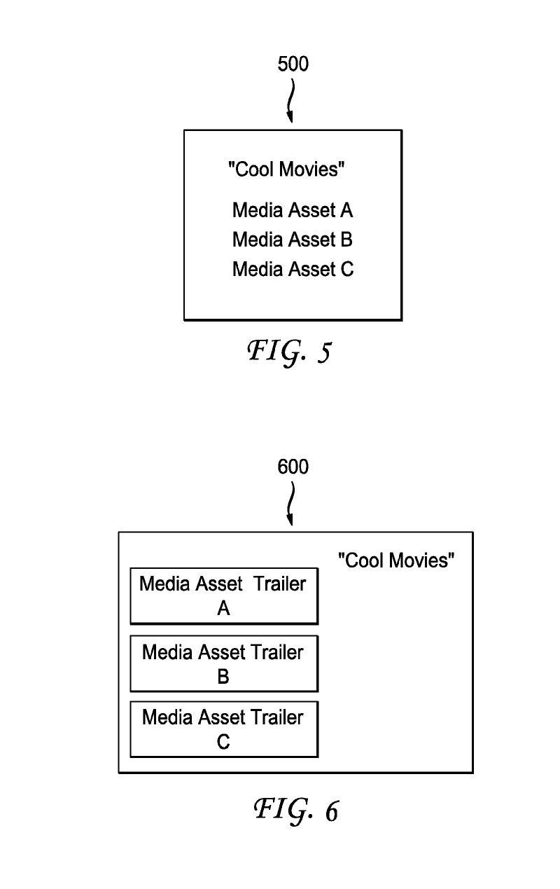

FIG. 5 is an representation of a user interface 500 that displays a list of selected media assets that are part of media asset list titled “Cool Movies”. In accordance with the exemplary principles described previously, a user has created a list of media assets that can be transmitted to different parties. The list of media assets are made of media asset A, media asset B, and media asset C.

In FIG. 6, a representation of a user interface 600 is shown for the case where a list of media assets made up of proprietary elements are to be transmitted to a destination device that is registered with a media service. In addition for this example, the requestor of the list for “Cool Movies” is also registered with the media service. Specifically, trailers comporting to media assets A, B, and C, are made available from media server 102. Other examples of proprietary elements can be used, in accordance with the exemplary principles.

FIG. 7 presents a user interface 700 where public elements are used for a list of media assets. In this example, either the list requestor is not registered with a media service or a device that will receive the list of media assets at a specified destination address is not registered with the media service. Hence, the public elements for the list called “Cool Movies” is provided to the device at the destination address by media service 102 comprise pictures of a media assets A, B, and C. This is contrast to the trailers that are made available to registered parties as shown in FIG. 6.

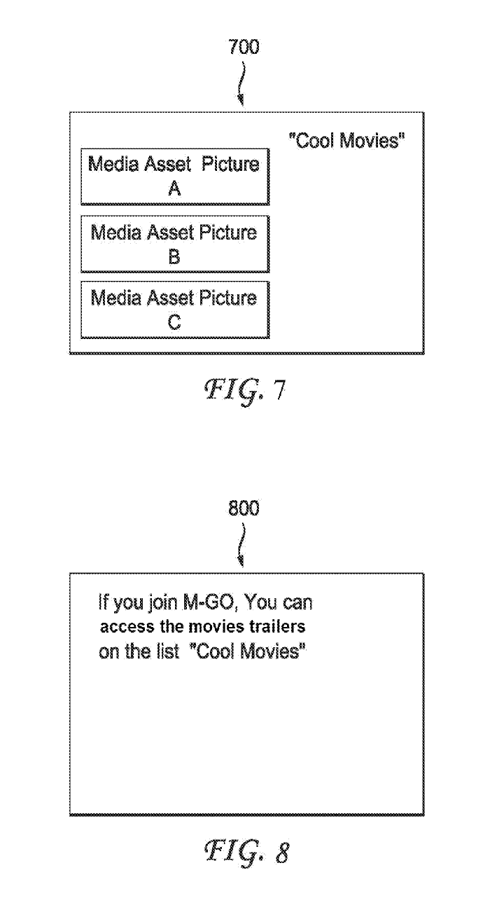

FIG. 8 presents a user interface 800 that invites an un-registered party to register with a media service to receive trailers that comport to the list “Cool Movies”. If the party decides to register, the user interface of FIG. 6 can be made available to the registered party. If the party decides not to register, then the user interface of FIG. 7 is made available to the un-registered party. Other examples are possible in accordance with the described principles.

1. A method for generating a representation of a media service comprising:
determining a requestor requesting said representation and a destination location;
selecting at least one of a proprietary element and a public element, where said at least one proprietary element and a public element is selected in view of said requestor and destination address; and
transmitting information for rendering said representation of said media service to said destination address, said information including said selected at least one of a proprietary element and a public element.

2. The method of claim 1 where said requestor is a user of said media service.

3. The method of claim 1 where said representation is at least one of a web page, media detail information corresponding to a media service, poster art corresponding to a media service, a media asset list, and an information screen.

4. The method of claim 1 where said at least one proprietary element is only selected when said requestor is a registered user of said media service and said destination location is associated with a device registered with said media service.

5. The method of claim 1 where said at least one public element is selected when said requestor is not a registered user of said media service.

6. The method of claim 1 where said at least one public element is selected when said destination location is associated with a device that is not registered with said media service.

7. The method of claim 1 comprising the additional steps of:
verifying via a database whether said requestor of a media service representation is a registered user of said media service; and
providing said requestor with an offer to register with said media service when said verification step determines that said requestor of a media service is not a registered user of said media service.

8. The method of claim 1 comprising the additional steps of:
verifying via a database whether said destination address comports to a device that is registered with said media service; and
providing said device with an offer to register said device with said media service when said verification step determines that said device is not registered with said media service.

9. The method of claim 1 where said content requestor is said media service.

10. The method of claim 1 comprising the additional steps of:
determining a list of media assets comprising at least one media asset, said list of media assets comporting to selections made by at least one of a user and said media service; and
selecting a representation of said at least one media asset using at least one of a proprietary element comporting to said at least one media asset and a public element comporting to said at least one media asset, said determination is made in view of said requestor and destination address.

11. The method of claim 10 comprising an additional step of transmitting said list to said destination address, said list including said selected at least one of a proprietary element comporting to said at least one media asset and a public element comporting to said at least one media asset.

12. The method of claim 11 where said at least one of a proprietary element comporting to said at least one media asset is selected when said requestor is a registered user of said media service and a device at said destination address is registered with said media service.

13. The method of claim 11 where said at least one of a public element comporting to said at least one media element is selected when said requestor is not a registered user of said media service or a device at said destination address is not registered with said media service.

14. The method of claim 1 where said proprietary element is at least one of a video, a picture, an audio clip, a special feature, a game, a streaming audio presentation, a streaming video presentation, and poster art.

15. The method of claim 1 where said public element is at least one of a video, a picture, an audio clip, a special feature, a game, a streaming audio presentation, a streaming video presentation, and poster art.

16. An apparatus that generates a representation of a media service comprising:
a processor configured to identify a requestor requesting said representation and a destination location;
a processor configured to select at least one of a proprietary element and a public element, where said at least one proprietary element and a public element is selected in view of said requestor and destination address; and
a network interface to transmit information for rendering said representation of said media service to said destination address, said information including said selected at least one of aproprietary element and a public element.

17. The apparatus of claim 16 additionally comprising:
a processor configured to verify via a database whether said requestor of a media service representation is a registered user of said media service; and
a processor configured to provide said requestor with an offer to register with said media service when said verification step determines that said requestor of a media service is not a registered user of said media service.

18. The apparatus of claim 16 additionally comprising:
a processor configured to verify via a database whether said destination address comports to a device that is registered with said media service; and
a processor configured to provide said device with an offer to register said device with said media service when said verification step determines that said device is not registered with said media service.

19. The apparatus of claim 16 additionally comprising:
a processor configured to determine a list of media assets comprising at least one media asset, said list of media assets comporting to selections made by at least one of a user and said media service; and
a processor configured to select a representation of said at least one media asset using at least one of a proprietary element comporting to said at least one media asset and a public element comporting to said at least one media asset, said determination is made in view of said requestor and destination address.
